(19) United States
(12) Patent Application Publication
(10) Pub. No.: US 2008/0095360 A1
(43) Pub. Date: Apr. 24, 2008

(54) Signature System and Signature Method

(76) Inventors: Camille Vuillaume, Tokyo (JP); Katsuyuki Okeya, Sagamihara (JP); Masayuki Yoshino, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/848,386

(22) Filed: Aug. 31, 2007

(30) Foreign Application Priority Data
Oct. 19, 2006 (JP) 2006-284637

(51) Int. Cl. H04L 9/30; H04L 9/28

(52) U.S. Cl. 380/44; 380/28; 713/180

(57) ABSTRACT

A signature system in which size of data to be transmitted is small and data can be processed efficiently in a Merkle signature system having high security. A processing part 112 of a smartcard 110 divides a message to be signed into groups of specific numbers of bits, starting from the first bit of the message. Then, respective partial one-time signatures of the groups are generated by encrypting each group by a one-way function processing part 112c. The partial one-time signatures are sequentially outputted to a verification apparatus through a interface part 113.

### INCORPORATION BY REFERENCE

The present application claims a priority from the Japanese patent application No. 2006-284637 filed on Oct. 19, 2006, the content of which is hereby incorporated by reference.

### BACKGROUND OF THE INVENTION

The present invention relates to a signature system and a signature method for verifying a digital signature.

A digital signature is encrypted data by which an identity of the sender of a message and the integrity of the message can be certified.

Merkle signatures have been developed as a simple solution to a problem of low scalability of one-time signature which is one of the methods for implementing digital signatures.

As described in U.S. Pat. No. 4,309,569 (hereinafter, referred to as Document 1), Merkle signatures provide a method in which a plurality of instances of a one-time signature system are used to authenticate each one-time public key with respect to a single master public key. Particularly, a compression function that compresses two data blocks into one data block is used to generate a binary tree having one-time public keys as its leaves and a master public key as its root. The master public key is delivered only once and can be used for verifying all signatures generated by the system.

Further, a de facto standard of public key cryptosystems and digital signature is RSA. Security of RSA is based on difficulty of factorization of a large integer into the product of two prime numbers. The current technology and algorithm can not solve the problem when the integer is sufficiently large (usually 1024 bits).

As described, however, in J. Buchmann et al. “Post-Quantum Signatures”, Cryptology ePrint Archive: Report 2004/297 (hereinafter, referred to as Document 2), it is known that a new type of computer called a quantum computer can easily find such prime factors. Thus, it is said that the widely-used public key cryptosystems will be unsafe when a quantum computer is realized.

### SUMMARY OF THE INVENTION

In Merkle signature described in Document 1, signature size is very large. Large signatures generate congestion of a network. And particularly in the case where a smartcard is used for signing, a large signature requires transfer of mass data through a network interface having a narrow bandwidth, and thus the processing takes a lot of time.

Further, since it is possible that a quantum computer is realized in the near future, it is necessary to provide an alternative technology replacing the currently-used public key cryptosystems such as RSA.

Thus, the present invention provides a signature system that can reduce size of data to be transmitted and process data efficiently in the Merkle signature system having a high level of security.

According to the present invention, an apparatus on the signing side signs data in groups of specific number of bits of the data, and sends the signatures sequentially to an apparatus on the verifying side, and the apparatus on the verifying side processes the received signatures sequentially, and a one-time public key can be generated when all the signatures are received.

For example, the present invention provides a signature system in which a digital signature generated by a first computer is verified by a second computer, wherein: a processing part of the first computer divides data to be signed digitally into groups of a specific number of bits sequentially starting from a top bit of the data, inputs each group to a one-way function so as to generate respective partial signatures for the groups, and outputs the generated partial signatures sequentially to the second computer.

Thus, according to the present invention, size of data transmitted can be made small and processing can be performed efficiently, while employing Merkle signature having high security.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a schematic block diagram showing a signature system of a first embodiment of the present invention;

FIG. 2 is a schematic block diagram showing a smartcard;

FIG. 3 is a schematic block diagram showing a reading apparatus;

FIG. 4 is a schematic block diagram showing a verification apparatus;

FIG. 5 is a diagram for explaining a one-time signature and a one-time public key;

FIG. 6 is a diagram for explaining processing of calculating a master public key from one-time public keys;

FIG. 7 is a sequence diagram showing processing in the signature system of the first embodiment;

FIG. 8 is a schematic block diagram showing a smartcard of a second embodiment of the present invention;

FIG. 9 is a schematic block diagram showing a verification apparatus used in a signature system of the second embodiment;

FIG. 10 is a diagram for explaining one-time signature and one-time public key;

FIG. 11 is a diagram for explaining processing of calculating a master public key from one-time public keys;

FIG. 12 is a sequence diagram showing processing in the signature system of the second embodiment;

FIG. 13 is a schematic block diagram showing a signature system of a third embodiment of the present invention;

FIG. 14 is a schematic block diagram showing a signing apparatus;

FIG. 15 is a schematic block diagram showing a verification apparatus;

FIG. 16 is a diagram for explaining a node;

FIG. 17 is a diagram for explaining processing for verification in the third embodiment;

FIG. 18 is a sequence diagram showing processing in the signature system of the third embodiment;

FIG. 19 is a schematic view showing an IC card;

FIG. 20 is a schematic block diagram showing a computer; and

FIG. 21 is a schematic block diagram showing a computer.

### DETAILED DESCRIPTION OF THE EMBODIMENTS

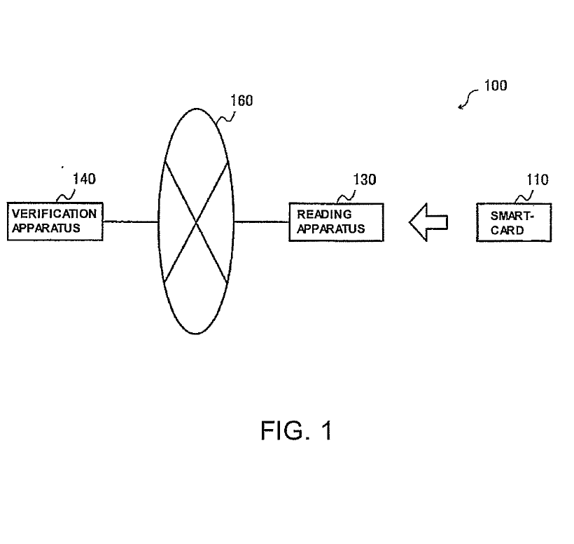

FIG. 1 is a schematic block diagram showing a signature system 100 of a first embodiment of the present invention.

As shown in the figure, the signature system 100 comprises a smartcard 110, a reading apparatus 130, and a verification apparatus 140. And, the reading apparatus 130 and the verification apparatus 140 can send and receive information to and from each other through a network 160.

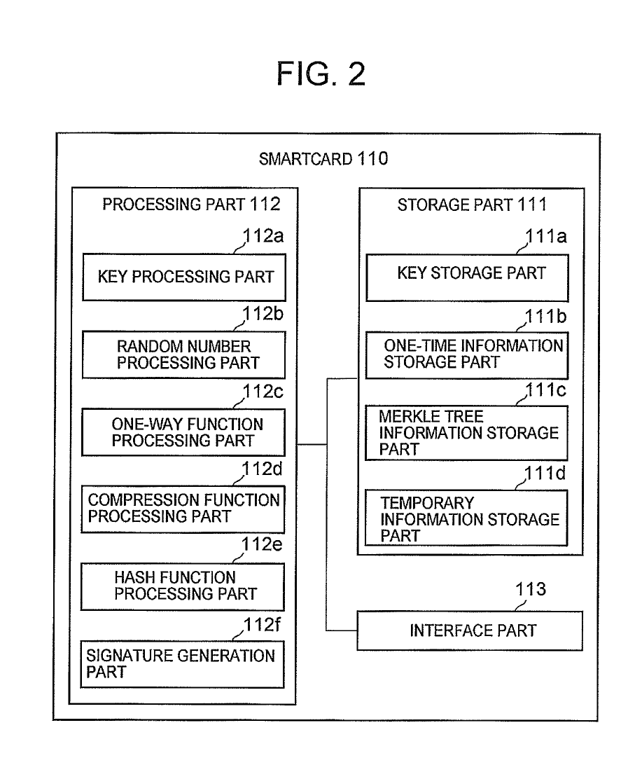

As shown in FIG. 2 (a schematic block diagram showing the smartcard 110), the smartcard 110 comprises a storage part 111, a processing part 112 and a interface part 113.

The storage part 111 comprises a key storage part 111a, a one-time information storage part 111b, a Merkle tree information storage part 111c and a temporary information storage part 111d.

The key storage part 111a stores information that specifies a secret seed and a public seed used in the Advanced Encryption Standard (AES).

The secret seed and the public seed can be prepared by a known method. For example, a random number generation part for generating a random number is provided in the processing part 112, and two numbers generated by the random number generation part are stored in the key storage part 111a, one as the secret seed and the other as the public seed.

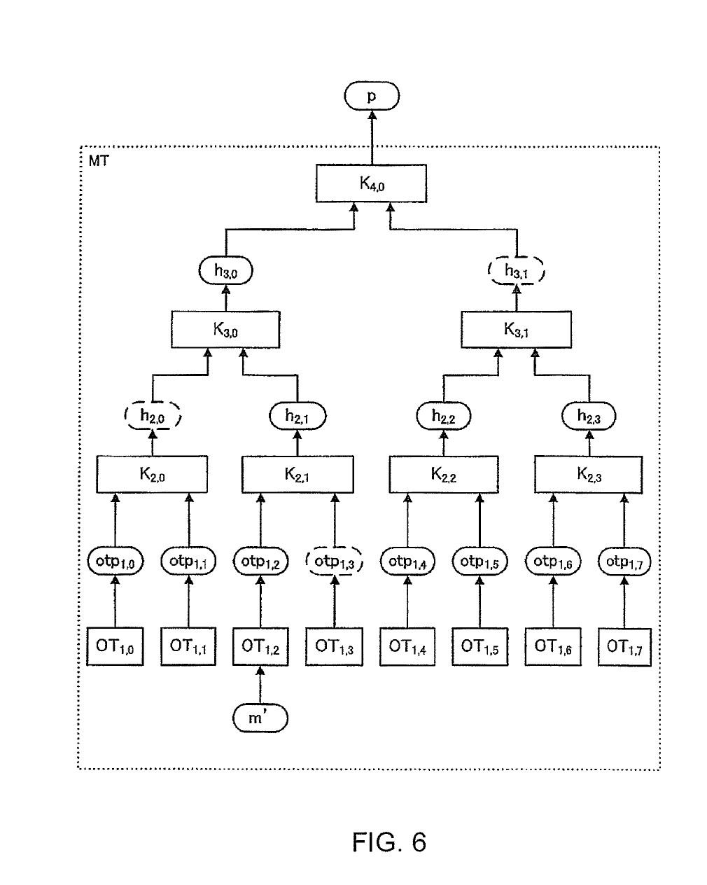

The one-time information storage part 111b stores, for each one-time signature, secret information used for that one-time signature and an index corresponding to the secret information. In the present embodiment, these pieces of information are stored in association with respective one-time signature indexes. Here, each one-time signature index is identification information for identifying uniquely the one-time signature concerned. One-time signature index will be described in detail later referring to FIG. 6.

The Merkle tree information storage part 111c stores information that specifies an authentication path required for calculating a master public key from one-time public key. An authentication path is stored for each one-time signature (i.e. for each one-time signature index) for generating a one-time public key. An authentication path will be described in detail later referring to FIG. 6.

The temporary information storage part 111d stores information required for processing in the processing part 112 described in the following.

The processing part 112 comprises a key processing part 112a, a random number processing part 112b, a one-way function processing part 112c, a compression function processing part 112d, a hash function processing part 112e, and a signature generation part 112f.

The key processing part 112a generates the secret information used for one-time signature. Each piece of secret information is generated by applying AES to an index assigned to that piece of information, using a key, i.e. a secret seed stored in the key storage part 111a.

The detailed calculation method of AES is described in Joan Daemen and Vincent Rijmen, “The Design of Rijndael: AES—The Advanced Encryption Standard”, Springer-Verlag, 2002.

The secret information generated by the key processing part 112a is stored together with the associated indexes to the one-time information storage part 111b.

Although the AES cryptosystem is employed in the present embodiment, this mode is not restrictive. For example, another block cipher or a hash function may be employed.

The random number processing part 112b performs AES encryption by using key information with respect to some counter value.

For example, in the present embodiment, an index assigned to each function is inputted as a counter value, and an initial vector is generated by the AES encryption using a public seed stored in the key storage part 111a as a key. The generated initial vector is outputted to the one-way function processing part 112c and the compression function processing part 112d described below.

Here also, although the AES cryptosystem is employed in the present embodiment, this is not restrictive. For example, another block cipher or a hash function may be employed.

The one-way function processing part 112c receives, as its input, the initial vector generated by the random number processing part 112e, and performs AES encryption on the initial vector using, as the key information, the secret information generated by the key processing part 112a.

Here also, although the AES cryptosystem is employed in the present embodiment, this is not restrictive. For example, another block cipher or a hash function may be employed.

The compression function processing part 112d receives, as its input, the initial vector generated by the random number processing part 112e, and performs AES using, as key information, one output value to be compressed out of output values of the one-way function processing part 112c, to calculate an encrypted value. Next, using the other output value to be compressed as key information, the compression function processing part 112d performs AES encryption on the encrypted value, to calculate an encrypted value. Further, the compression function processing part 112d performs AES on the encrypted value by using the above-mentioned one output value to be compressed as key information, to calculate a compressed value.

For example, writing an initial vector as v, one output value of the one-way function as a, and the other output value as b, then the compression function processing part 112d carries out a calculation according to the following expression (1).

h=AESₐ(AES_{b}(AESₐ(v))) (1)

Here, h indicates a compressed value, AESₐ AES encryption using a as key information, and AES_{b} AES encryption using b as key information.

Actually, the triple AES structure characteristic of the present embodiment corresponds to the two-key triple-encryption method. When the two-key triple-encryption method is used not as a compression function but purely as an encryption function, it is used for improving security of a weak cryptosystem such as DES. As a matter of fact, however, in the case of aiming purely at encryption, the three-key triple-encryption method is favorable in most situations. In that case, the third input m₃ is used in the last encryption step. Although the three-key triple-encryption method is secure in the context of encryption, it is not completely safe when it is used as a compression function. On the other hand, the two-key triple-encryption method is a secure compression function. It has not been known until now to use the two-key triple-encryption method as a compression function.

The hash function processing part 112e generates a hash digest of a message to be signed.

The signature generation part 112f generates a one-time signature from the hash digest generated by the hash function processing part 112e.

In the present embodiment, two indexes are assigned to each bit of the hash digest from the most significant bit of the hash digest. In the case where the value of a bit is “1”, a partial one-time signature is generated by associating secret information corresponding to the first of the two indexes assigned to the bit with an encrypted value obtained by the one-way function processing part 112c performing the AES encryption on secret information corresponding to the second index. On the other hand, in the case where the value of a bit is “0”, a partial one-time signature is generated by associating an encrypted value obtained by the one-way function processing part 112c performing the AES encryption on the secret information corresponding to the first of the two index assigned to the bit with the secret information corresponding to the second index. An example of this operation will be described in detail referring to FIG. 6.

The interface part 113 is an interface for sending and receiving information to and from the below-described reading apparatus 130. Connection between the interface part 113 and the reading apparatus 130 may be realized without contacts (by transmitting data wirelessly using antennas) or with contacts.

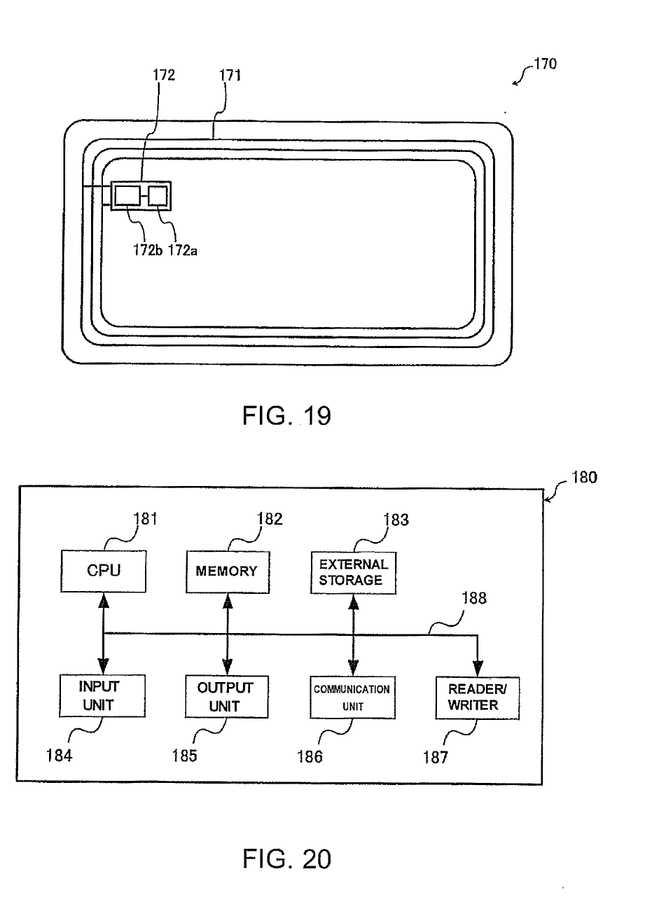

The smartcard of the above-described configuration can be implemented by an IC card 170 as shown in FIG. 19, for example.

The IC card 170 comprises an antenna 171 and an IC chip 172 connected to the antenna 171.

Here, the storage part 111 can be implemented by an external storage 172a such as Electronically Erasable and Programmable Read Only Memory (EEPROM) in the IC chip 172. The processing part 112 can be implemented when a Central Processing Unit (CPU) 172b in the IC chip 172 executes a prescribed program stored in the external storage 172a. And, the interface part 113 can be implemented by the antenna 171.

The processing performed in the processing part 112 may be performed by hardware, i.e. by an integrated logic IC such as an Application Specific Integrated Circuit (ASIC) or a Field Programmable Gate Array (FPGA), for example.

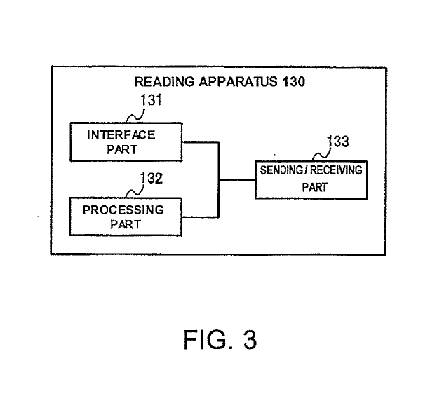

FIG. 3 is a schematic block diagram showing the reading apparatus 130.

As shown in the figure, the reading apparatus 130 comprises a interface part 131, a processing part 132 and a sending/receiving part 133.

The interface part 131 is an interface for sending and receiving information to and from the smartcard 110.

The processing part 132 is a control part that controls processing in the reading apparatus 130 as a whole.

The sending/receiving part 133 is an interface for sending and receiving information through the network 160, and may be implemented by a Network Interface Card (NIC), for example.

The reading apparatus 130 can be implemented by a so-called computer 180 shown in FIG. 20, for example.

The computer 180 comprises a CPU 181, a memory 182, an external storage 183, an input unit 184, an output unit 185, a communication unit 186, a reader/writer 187, and a bus 188 connecting the mentioned components.

For example, the interface part 131 can be implemented by the reader/writer 187 that can read and write information from and to the smartcard. The processing part 132 can be implemented when prescribed programs stored in the external storage 183 is read to the memory 182 and executed by the CPU 181. And, the sending/receiving part 133 can be implemented by the communication unit 186 such as an NIC.

Programs executed in various units may be previously stored in the external storage 183 in the computer 180, or may be introduced from a removable external storage medium that the computer 180 can use or from another apparatus through a communication medium (such as the network 160 or a carrier wave or a digital signal propagating through the network 160 or the like) when necessary.

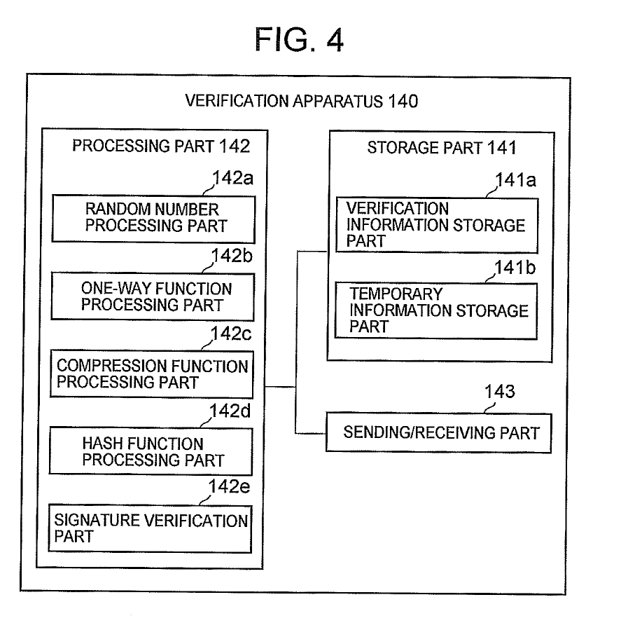

FIG. 4 is a schematic block diagram showing the verification apparatus 140.

As shown in the figure, the verification apparatus 140 comprises a storage part 141, a processing part 142, and a sending/receiving part 143.

The storage part 141 comprises a verification information storage part 141a and a temporary information storage part 141b.

The verification information storage part 141a stores information for verifying a partial one-time signature read from the smartcard 110.

For example, in the present embodiment, the verification information storage part 141a stores the below-described master public key of a Merkle tree and a public seed used by a random number generation part 142a for calculating an initial vector.

The temporary information storage part 141b temporarily stores information required for processing in the below-described processing part 142.

The processing part 142 comprises a random number generation part 142a, a one-way function processing part 142b, a compression function processing part 142c, a hash function processing part 142d, and a signature verification part 142e.

The random number processing part 142a performs processing similar to the processing of the random number processing part 112b in the smartcard 110. However, a public seed used by the random number processing part 142a is one stored in the verification information storage part 141a.

The one-way function processing part 142b performs processing similar to the processing of the one-way function processing part 112c in the smartcard 110.

The compression function processing part 142c performs processing similar to the processing of the compression function processing part 112d in the smartcard 110.

The hash function processing part 142d generates a hash digest of a message read from the smartcard 110.

The signature verification part 142e calculates a one-time public key from partial one-time signatures read from the smartcard 110, and calculates a master public key from the calculated one-time public key and an authentication path read from the smartcard 110. Then, the signature verification part 142e compares the calculated master public key with the master public key stored in the verification information storage part 141a, and gives approval when both master public keys coincide. Otherwise, the signature verification part 142e gives rejection.

The sending/receiving part 143 is an interface for sending and receiving information through the network 160, and may be implemented by an NIC, for example.

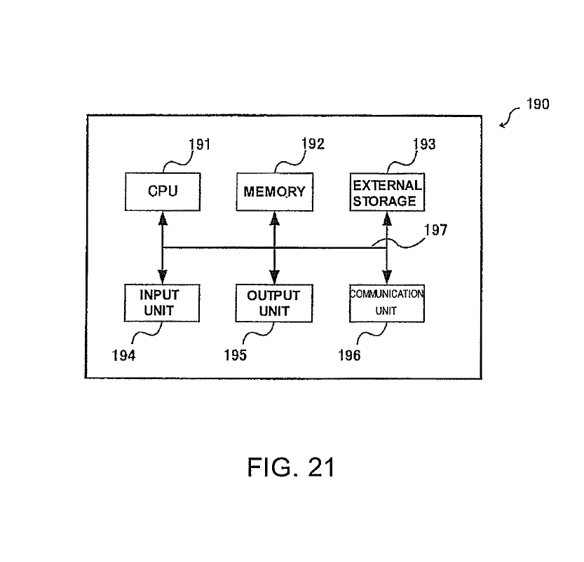

The above-described verification apparatus 140 can be implemented by a so-called computer 190 as shown in FIG. 21.

For example, the storage part 141 can be implemented by an external storage 193. The processing part 142 can be implemented when prescribed programs stored in the external storage 193 is read to a memory 192 and executed by a CPU 191. And, the sending/receiving part 143 can be implemented by a communication unit 196 such as an NIC.

Programs executed in various units may be previously stored in the external storage 193 in the computer 190, or may be introduced from a removable external storage medium that the computer 190 can use or from another apparatus through a communication medium (such as the network 160 or a carrier wave or a digital signal propagating through the network 160 or the like) when necessary.

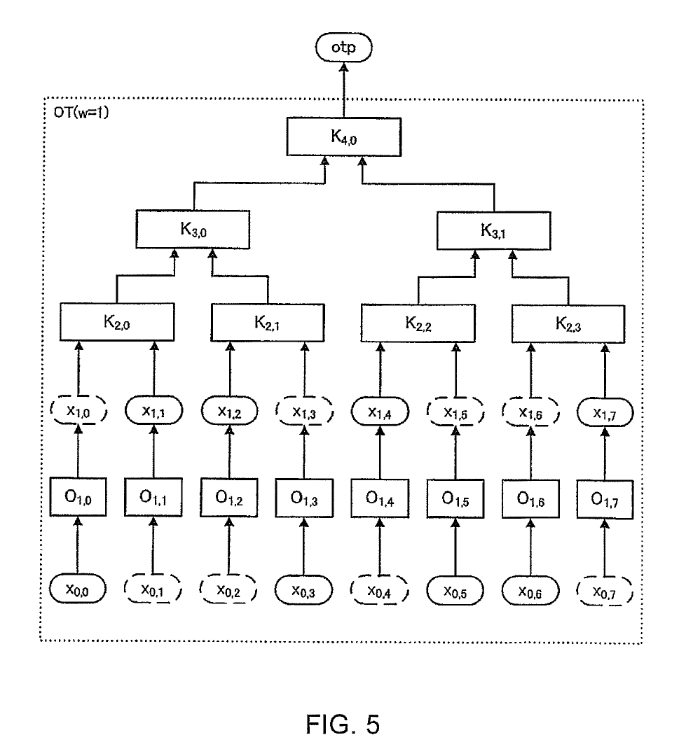

FIG. 5 is a diagram for explaining one-time signature and one-time public key in the present embodiment.

In the present embodiment, a one-time signature is calculated by combining one-way functions, and a one-time public key is calculated by combining compression functions.

In the present embodiment, 2n pieces of secret information x_{0,0}, x_{0,1}, . . . , x_{0,2n-1} are used to sign a message (digest) m of n bits. These pieces of secret information are generated by the key processing part 112a of the smartcard 110 and stored in the one-time information storage part 111b.

The subscripts (0, 0), (0, 1), . . . , (0, 2n−1) of the secret information x_{0,0}, x_{0,1}, . . . , x_{0,2n-1} indicate indexes. The first term of each index is assigned an identifier “0” that indicates secret information, and the second term is assigned a serial number that starts from 0 and indicates the order of assignment of the index.

Indexes assigned to secret information are not limited to this mode. Any indexes can be used as far as a first term can identify secret information and a second term can identify a position from the top of a message (digest) to which the secret information in question is assigned.

A one-time public key is a root of a binary tree structure (OT) whose leaves are values O(x_{0,0}), O(x_{0,1}), . . . , O(x_{0,2n-1}) calculated by using a one-way function O. The one-time public key is calculated by recursively combining two of these values by means of a compression function K.

As shown in FIG. 5, an index is also given to a function that indicates calculation performed in each node arranged in the binary tree structure. That is to say, subscripts of the one-way functions O_{1,0}, O_{1,1}, . . . , O_{1,7} and subscripts of the compression functions K_{4,0}, K_{3,0}, K_{2,0}, K_{2,2}, K_{2,3} are indexes.

As for each of the indexes assigned to the functions at those nodes, the first term is assigned a serial number that starts from 1 and indicates the height (i.e. distance) from a leaf, and the second term a serial number that starts from 0 and indicates the position (the order of calculation) in that height (distance) in question.

Indexes assigned to these functions are not limited to this mode, and any indexes can be used as far as they can specify height (distance) from a leaf and position (order of calculation) in the height in question in a binary tree structure.

First, a method of generating a one-time signature will be described. A one-time signature is generated by the signature generation part 112f of the smartcard 110.

In the present description, the case where a message of 4 bits is signed will be described for the sake of simplicity. The description, however, can be applied to a message of 128 bits or 256 bits used actually in many cases.

To sign a message of 4 bits, eight pieces of secret information, i.e. x_{0,0}, x_{0,1}, . . . , x_{0,7} are required. As a favorable embodiment of the present invention, the key processing part 112a generates secret information by AES encryption of each index (0, 0), (0, 1), . . . , (0, 7) using the secret seed stored in the key storage part 111a as a key. In other words, secret information is calculated by the following expression (2).

x_{0,i}=AESₛₛ(0∥i) (2)

Here, ss indicates the secret seed stored in the key storage part 111a, (0∥i) indicates combining of an index by the known method, and i=0, 1, 2, 3, . . . , 7.

Next, the leaves x_{1,0}, x_{1,1}, x_{1,2}, x_{1,3}, x_{1,4}, x_{1,5}, x_{1,6} and x_{1,7} of the binary tree can be calculated by inputting the secret information x_{0,0}, x_{0,1}, . . . , x_{0,7} into the one-way functions respectively.

In the present embodiment, two indexes are assigned to each bit of a message (digest) to be signed, starting from the first bit of the message (digest). And, in the case where the value of a bit corresponding to two indexes is “0” in the message (digest) to be signed, then secret information corresponding to the first index (positioned at the left) of the two assigned indexes is paired with a leaf that is calculated by inputting secret information corresponding to the second index (positioned at the right) to the one-way function. The obtained pair is a partial one-time signature.

On the other hand, in the case where the value of a bit corresponding to two indexes is “1” in the message (digest) to be signed, then a leaf that is calculated by inputting secret information corresponding to the first index (positioned at the left) of the assigned indexes is paired with secret information corresponding to the second index (positioned in the right), to obtain a partial one-time signature.

For example, in FIG. 5, a one-time signature ((x_{1,0}, x_{0,1}), (x_{0,2}, x_{1,3}), (x_{0,4}, x_{1,5}), (x_{1,6}, x_{0,7})) is generated for a message “1001” to be signed.

For each message to be signed, a different binary tree structure as shown in FIG. 5 is used. Accordingly, to identify a used binary tree structure, a one-time signature index is assigned to each binary tree structure. For example, the subscripts (1, 0), (1, 1), . . . , (1, 7) of OT_{1,0}, OT_{1,1}, . . . , OT_{1,7} of FIG. 6 indicate one-time signature indexes. The first term of each index is assigned an identifier “1” that indicates one-time signature, and the second term is assigned a serial number that starts from 0 and indicates the order of using the one-time signature (binary tree structure) in question.

One-time indexes are not limited to this mode, and any indexes can be used as far as a first term can identify one-time signature (binary tree structure) and a second term can identify the order of using one-time signature (binary tree structure).

The signature generation part 112f of the smartcard 110 sends the generated partial one-time signatures sequentially to the verification apparatus 140 through the reading apparatus 130. In sending a partial one-time signature, the one-time signature index concerned or the index corresponding to the secret information used to generate the partial one-time signature is sent together with the partial one-time signature so that the binary tree structure required for calculating a one-time public key can be specified.

When a partial one-time signature is received from the smartcard 110, the signature verification part 142e of the verification apparatus 140 specifies a piece of secret information included in the received one-time signature on the basis of the corresponding bit value of the already-received message. Then, by inputting the piece of secret information to the one-way function and by using the initial vector that is calculated from the corresponding index, the value of the missing leaf is calculated. Calculation is performed sequentially by inputting values of leaves to the corresponding compression function K in the binary tree structure shown in FIG. 5. Thus, when all the partial one-time signatures are received, a one-time public key as the root of the binary tree is calculated.

Further, the signature verification part 142e of the verification apparatus 140 calculates a master public key on the basis of calculated one-time public keys.

FIG. 6 is a schematic diagram for explaining processing of calculating a master public key from one-time public keys.

The signature verification part 142e combines one-time public keys otp_{1,0}, otp_{1,1}, . . . , otp_{1,7} by using compression functions, to calculate one master public key p.

Here, the subscripts (1, 0), (1, 1), . . . , (1, 7) of the one-time public keys otp_{1,0}, otp_{1,1}, . . . , otp_{1,7} indicate one-time signature indexes.

Further, the subscripts (2, 0), (2, 1), . . . , (4, 0) added to the compression functions K as nodes of the Merkle tree also indicate indexes. These are similar to ones described referring to FIG. 5.

To calculate an initial vector used in each compression function, a value obtained by combining the index of the compression function by the known method is inputted, and AES encryption is performed by using the public seed stored in the verification information storage part 141a as a key.

When the signature verification part 142e actually calculates the master public key p, all the one-time public keys are not combined by compression functions, but an authentication path sent from the smartcard 110 is used for calculation.

For example, as shown in FIG. 6, in the case where a one-time public key otp_{1,2} is calculated from a one-time signature m′ that in turn is calculated from a message to be signed, first the one-time public key otp_{1,2} and a one-time public key otp_{1,3} are combined by the compression function K_{2,1}, to calculate the compressed value h_{2,1}. Then, the compressed value h_{2,1} and the compressed value h_{2,0} are combined by the compression function K_{3,0}, to calculate a compressed value h_{3,0}. Further, the compressed value h_{3,0} and the compressed value h_{3,1} are combined by the compression function K_{4,0}, to calculate the master public key p.

In other words, the one-time public key otp_{1,2} corresponding to the one-time signature m′ requires the one-time public key otp_{1,3}, the compressed value h_{2,0} and the compressed value h_{3,1} as the authentication path.

Accordingly, the smartcard 110 calculates the one-time signature m′ from the message to be signed, and at the same time specifies the authentication path required for otp_{1,2} corresponding to the one-time signature m′ on the basis of the used secret information, from the information stored in the Merkle tree information storage part 111c. Then, the specified values are sent as the authentication path to the verification apparatus 140.

Here, to specify such an authentication path, it is sufficient that the Merkle tree information storage part 111c stores information (an index of each node) for specifying relation between nodes and information for specifying a compressed value calculated at each node. These pieces of information may be obtained by performing all calculation with respect to a Merkle tree and binary tree structures belonging to the Merkle tree for example at the time of setup of the signature system 100.

Then, the signature verification part 142e of the verification apparatus compares the master public key p calculated by the received one-time signature m′ and the authentication path with the master public key stored in the verification information storage part 141a. When both master public keys coincide, the signature verification part 142e approves the signature.

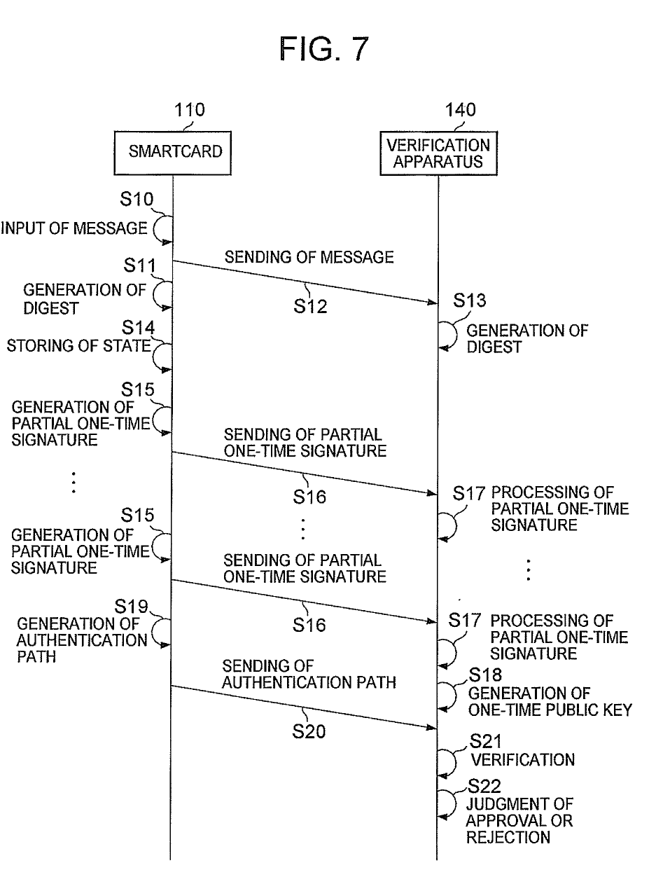

Processing in the above-described signature system 100 of the present embodiment will be described referring to the sequence diagram shown in FIG. 7. In the sequence diagram, the smartcard 110 and the verification apparatus 140 send and receive information through the reading apparatus 130.

First, the smartcard 110 receives input of a message m to be verified, and stores the message m to the temporary information storage part 111d (S10). Here, the message m may be received through the reading apparatus 130.

Then, the hash function processing part 112e calculates a digest H(m) of the received message m by using a prescribed hash function H (S11).

Further, the inputted message m is sent to the verification apparatus 140 through the sending/receiving part 133 of the reading apparatus 130 (S12).

Then, also the hash function processing part 142d of the verification apparatus 140 calculates the digest H(m) of the received message m by using the prescribed hash function H (S13).

Next, prior to calculation of a signature, the signature generation part 112f of the smartcard 110 stores the state of a signing side system including indexes used for the message m to the temporary information storage part 111d (S14). By storing such information, it is possible to prevent the system from using the same one-time signature even when the power supply is cut off.

Next, the signature generation part 112f of the smartcard 111 generates a partial one-time signature starting from the first bit of the digest H(m) of the message m (S15), and sends the generated partial one-time signatures sequentially to the verification apparatus 140 (S16).

Receiving a partial one-time signature, the verification apparatus 140 confirms the bit corresponding to the received partial one-time signature on the basis of the digest H(m) generated in the step S13, to specify secret information to be inputted to the one-way function. Thus, the verification apparatus 140 inputs the secret information to the one-way function processing part 142c to calculate the missing leaf of the binary tree structure by using the public seed stored in the verification information storage part 141a (S17).

By repeating the processing of the steps S15-S17 for all bits of the digest H(m), all leaves of the binary tree structures are calculated. Then, by inputting the leaves to the compression function processing part 142c, a one-time public key is generated (S18).

On the side of the smartcard 110, an authentication path to be sent to the verification apparatus 140 is generated (S19) and sent to the verification apparatus 140 (S20).

Receiving the authentication path, the verification apparatus 140 generates a master public key by using the generated one-time signature and the received authentication path (S21).

Then, when the verification result shows the coincidence between the generated master public key and the master public key stored in the verification information storage part 141a, the signature is approved. Otherwise, the signature is rejected (S22).

As described above, the present embodiment can perform generation and verification of a signature in parallel, and the processing time can be shortened. Further, since one signature requires information of only one binary tree, required information capacity is small. In the case of signing another message, information required for that message may be stored in the memory.

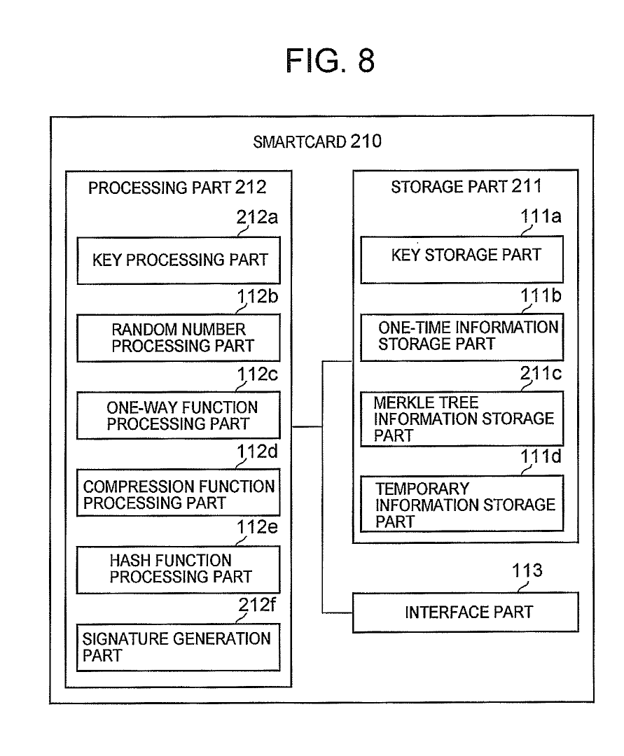

FIG. 8 is a schematic block diagram showing a smartcard 210 used in a signature system of a second embodiment of the present invention.

In comparison with the first embodiment, the smartcard 210 in the present embodiment is different in information stored in the Merkle tree information storage part 211c of the storage part 211 and processing in the key processing part 212a of the signature generation part 212f of the processing part 212. Thus, matters relating to these different points will be described in the following.

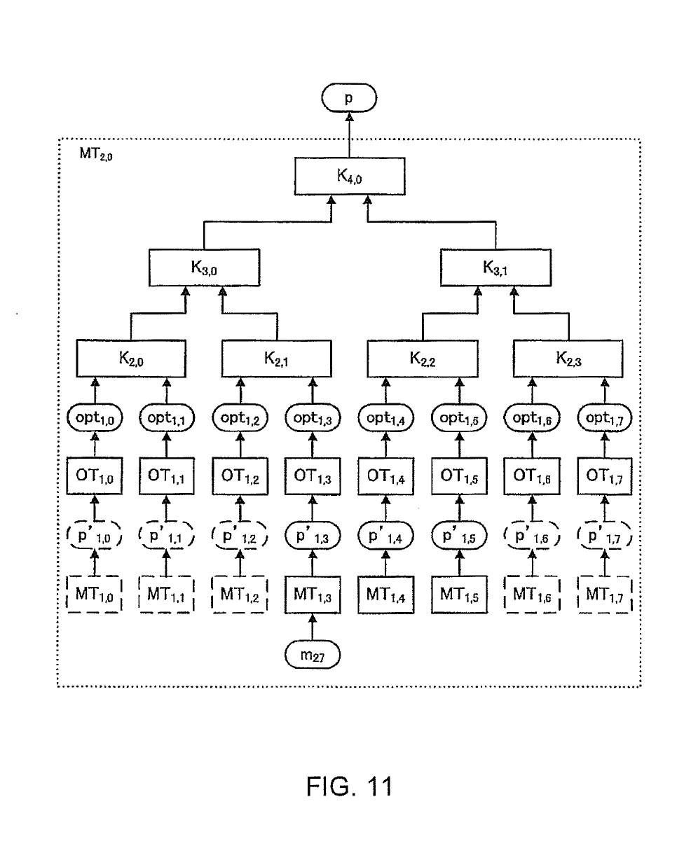

In the present embodiment, as described in detail later referring to FIG. 11, two Merkle trees, i.e. a lower Merkle tree and an upper Merkle tree, are used. Accordingly, the Merkle tree information storage part 211c stores information (an index of each node) for specifying relation between nodes and information for specifying a compressed value calculated at each node for each of the lower and upper Merkle trees so that authentication paths in these two Merkle trees can be specified.

Further, the Merkle tree information storage part 211c in the present embodiment stores, for each Merkle tree, information specifying indexes used in a lower side Merkle tree.

Further, the Merkle tree information storage part 211c in the present embodiment stores one-time signature of the upper side Merkle tree. The one-time signature of the upper side Merkle tree is generated from a lower side master public key, i.e. the root of the lower Merkle tree.

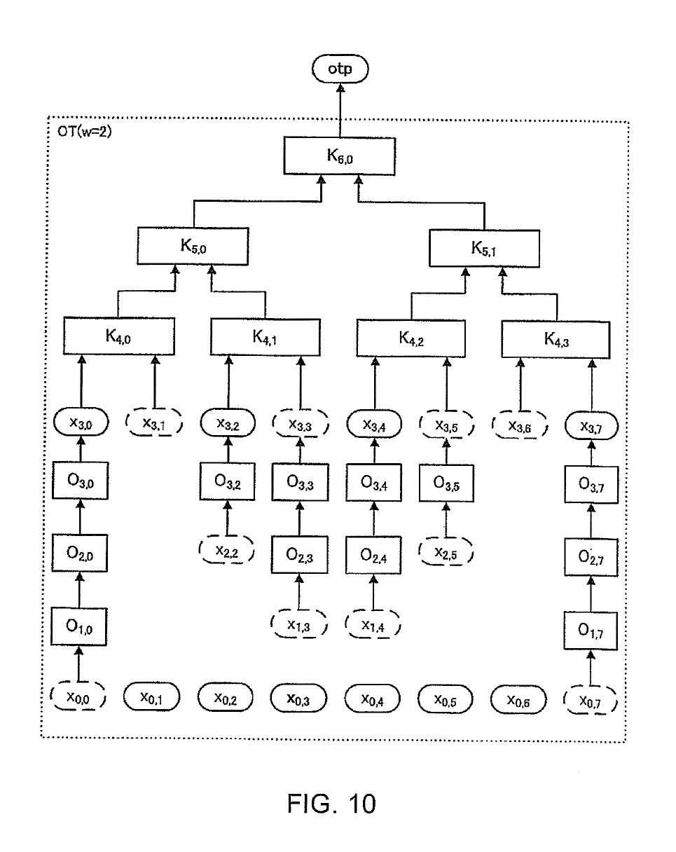

Further, in the present embodiment, as described in detail later referring to FIG. 10, any number of successive bits (two successive bits in the present embodiment) of a message (or its digest) to be signed is taken as a group (hereinafter, referred to as a quit), and a partial one-time signature is generated for each quit. Thus, the signature generation part 212f generates a partial one-time signature for each quit starting from the top bit of the message, and sends the partial one-time signature to the verification apparatus 240.

Further, the key processing part 212a in the present embodiment generates one-time signature from the lower side master public key as the root of the lower Merkle tree by the method shown in FIG. 10, and stores the generated one-time signature as one-time signature of the upper side Merkle tree to the Merkle tree information storage part 211c.

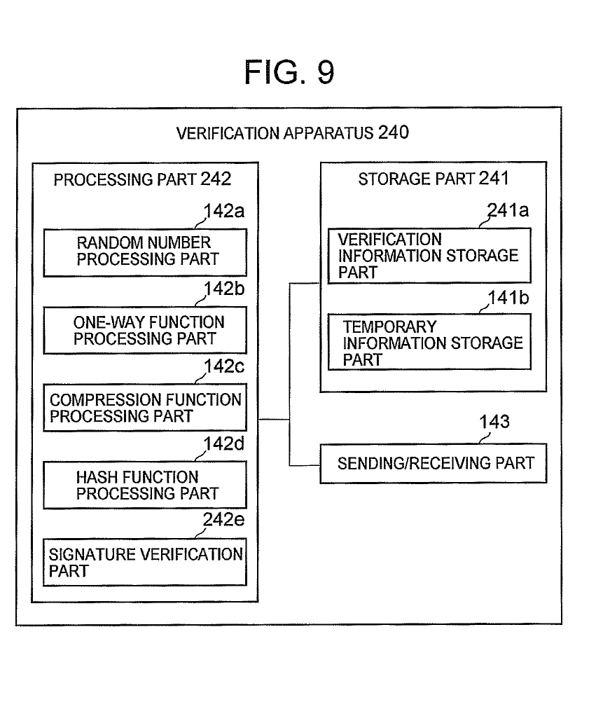

FIG. 9 is a schematic block diagram showing a verification apparatus 240 used in a signature system as the second embodiment of the present invention.

In comparison with the first embodiment, the verification apparatus 240 in the present embodiment is different in information stored in the verification information storage part 241a of the storage part 241 and processing in the signature verification part 242e of the processing part 242. Thus, matters relating to these different points will be described in the following.

In the present embodiment, as described in detail later referring to FIG. 11, the two Merkle trees, i.e. the lower Merkle tree and the upper Merkle tree, are used, and the verification information storage part 241a stores information for specifying master public keys in these two Merkle trees.

Similarly to the first embodiment, the verification information storage part 241a stores also a public seed used by the random number generation part 142a for calculating an initial vector.

Further, in the present embodiment, as described in detail later referring to FIG. 10, any number of bits of a message to be signed are taken as a quit, and a partial one-time signature is generated for each quit. And, with respect to a quit that is made of any number of bits starting from the top bit of a message, the signature verification part 142e specifies the number of times of input processing with respect to an element included in a partial one-time signature corresponding to the quit in question to one-way functions, to calculate a leaf in the lower Merkle tree.

FIG. 10 is a diagram for explaining a one-time signature and a one-time public key in the present embodiment.

Similarly to the first embodiment, a partial one-time signature in the present embodiment is also calculated by combining one-way functions, and a one-time public key is calculated by combining compression functions.

In the present embodiment, a group of two bits starting from the top of a message (digest) are taken as one quit (hereinafter, expressed as “q”), and a partial one-time signature is generated for each q. In the present embodiment, two pieces of secret information are used for signing one q.

To generate a partial one-time signature for each q, q is expressed as a value such that q=0 for a group of two bits (0, 0), q=1 for (0, 1), q=2 for (1, 0), and q=3 for (1, 1). Further, secret information x_{0,i} is used to define the following values. Here, O means a one-way function.

x_{1,i}=O_{1,i}(x_{0,i})x_{2,i}=O_{2,i}(O_{1,i}(x_{0,i}))x_{3,i}=O_{3,i}(O_{2,i}(O_{1,i}(x_{0,i})))

### With respect to a partial one-time signature, the following values are generated depending on the value of q.

When q=3, a partial one-time signature is x_{0,0} and x_{3,1}.

When q=2, a partial one-time signature is x_{1,0} and x_{2,1}.

When q=1, a partial one-time signature is x_{2,0} and x_{1,1}.

When q=0, a partial one-time signature is x_{3,0} and x_{0,i}.

These elements can be calculated in one way and are asymmetric. The reason can be easily understood from the following example. It is assumed that the first quit of a message is q=3. In that case, not only secret information x_{0,0} but also x_{3,1}=O_{3,1}(O_{2,1}(O_{1,1}(x_{0,1}))) is disclosed. Here, it is assumed that an attacker intercepts (x_{0,0}, x_{3,1}), and tries to sign a different quit q′ by using the pair. Even if the attacker could calculate x_{1,0}=O_{1,0}(x_{0,0}), x_{2,0}=O_{2,0} (O_{1,0}(x_{0,0})) or x_{3,0}=O_{3,0}(O_{2,0}(O_{1,0}(x_{0,0}))), he ends in failure. Since the attacker knows only x_{3,1} and O is one-way, he can calculate neither x_{2,1} nor x_{1,1} nor x_{0,1} that might be required for signing a message q′=0, 1 or 2.

For example, when a binary expression of a message is m=(11011000), then the message expressed in quits is M=(3120).

A one-time signature corresponding to this message becomes ((x_{0,0}, x_{3,1}), (x_{2,2}, x_{1,3}), (x_{1,4}, x_{2,5}), (x_{3,6}, x_{0,7})).

Then, the signature generation part 212f in the present embodiment generates partial one-time signatures (x_{0,0}, x_{3,1}), (x_{2,2}, x_{1,3}), (x_{1,4}, x_{2,5}) and (x_{3,6}, x_{0,7}) of the one-time signature ((x_{0,0}, x_{3,1}), (x_{2,2}, x_{1,3}), (x_{1,4}, x_{2,5}), (x_{3,6}, x_{0,7})), and sends the generated partial one-time signatures sequentially to the verification apparatus 240.

Then, receiving these partial one-time signatures, the signature verification part 242e of the verification apparatus 240 specifies received secret information on the basis of the values of the corresponding bits of the already-received message, specifies the number of times of input with respect each of elements included in the partial one-time signatures to one-way functions, and calculates values of missing leaves in the binary tree structure by inputting to the one-way functions the specified number of times. When the values x_{3,0}, x_{3,1}, . . . , x_{3,i} of all the leaves are specified, then compression functions are applied successively to calculate a one-time public key as the root of the binary tree.

FIG. 11 is a diagram for explaining processing of calculating a master public key from one-time public keys.

In the first embodiment, one-time public keys are calculated from one-time signatures, and the one-time public keys are inputted to one Merkle tree to calculate one master public key p.

On the other hand, in the present embodiment, the signature verification part 242e of the verification apparatus 240 calculates lower side one-time public keys from one-time signatures generated by the signature generation part 212f of the smartcard 210, and inputs the lower side one-time public keys to the lower side Merkle trees to calculate lower side master public keys p′, and verification is performed. Then, upper side one-time public keys are calculated from these lower side master public keys p′ and inputted to the upper side Merkle tree, to calculate an upper side master public key p.

Then, thus-calculated lower side master public keys p′ and the upper side master public key p are compared with the lower side and upper side master public keys stored in the verification information storage part 241a. When the comparison shows coincidence, the signature is authenticated.

As for the method of generating these master public keys p′, p, the processing in the first embodiment is simply repeated twice for the lower side and the upper side. Thus, detailed description of the method is omitted here.

Thus, since Merkle trees are used at two levels, information to be stored with respect to the lower Merkle tree for a given transaction is information on only one Merkle tree. Accordingly, the storage capacity required for the system is dramatically reduced.

To prevent use of the same index in different Merkle trees, the index of a Merkle tree is added to all the indexes used in that tree. For example, to calculate the fourth secret information of the one-time signature OT_{1,5} of the lower side Merkle tree MT_{1,7}, the following indexes are used together with a random number generator: x_{0,4}=AESₛₛ(1∥7∥1∥5∥0∥4). In other words, all indexes of all components are concatenated. Here, for simplification, only the index at the node in question is described.

Indexes for Merkle trees may be assigned by a method similar to the Merkle signature indexes.

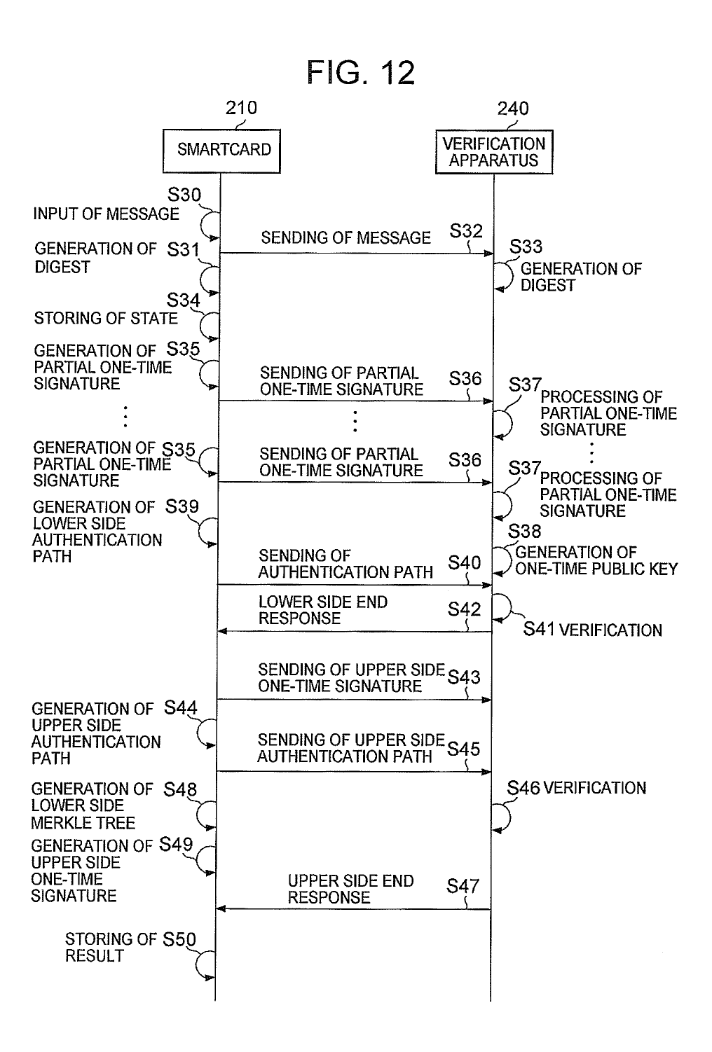

Operation in the signature system of the above configuration of the second embodiment will be described referring to the sequence diagram shown in FIG. 12. In the sequence diagram, the smartcard 210 and the verification apparatus 240 send and receive information through the reading apparatus 130.

First, the smartcard 210 receives input of a message m to be verified, and stores the received message m in the temporary information storage part 111d (S30). Here, the message m may be received through the reading apparatus 130, for example.

Then, the hash function processing part 112e calculates a digest H(m) of the received message m by using a prescribed hash function H (S31).

Further, the inputted message m is sent to the verification apparatus 240 through the sending/receiving part 133 of the reading apparatus 130 (S32).

Then, the hash function processing part 142d of the verification apparatus 240 calculates the digest H(m) of the received message m by using the prescribed hash function H (S33).

Next, prior to calculation of a signature, the signature generation part 212f of the smartcard 210 stores the state of a signing system including indexes used for the message m to the temporary information storage part 111d (S34). By storing such information, it is possible to prevent the system from using the same one-time signature even when the power supply is cut off.

Next, the signature generation part 212f of the smartcard 111 divides the digest H(m) of the message m into quits starting from the most significant bit, to generate partial one-time signatures (S35), and sends the partial one-time signatures sequentially to the verification apparatus 240 (S36).

Receiving the partial one-time signatures, the verification apparatus 240 identifies a quit corresponding to each of the received partial one-time signatures on the basis of the digest H(m) generated in the step S33, to specify the number of times of input with respect to an element included in the partial one-time signature in question to one-way functions. Then, the element is inputted to the one-way function processing part 142c to calculate a leaf of the binary tree by using the public seed stored in the verification information storage part 241a (S37).

By repeating the processing of the steps S35-S37 for all the bits of the digest H(m), all leaves of the binary tree structure are calculated. These leaves are inputted to the compression function processing part 142c, to generate a one-time public key (S38).

On the side of the smartcard 210, a lower side authentication path to be sent to the verification apparatus 240 is generated (S39) and sent to the verification apparatus 240 (S40).

Then, the one-time public key generated in the step S38 and the authentication path received in the step S40 are used to calculate a lower side master public key p′, and verification is performed (S41). When the signature is approved as a result of the verification, then the processing proceeds to the next step. Otherwise, the verification processing is ended. Here, assuming that the signature has been approved, the description is continued.

Next, the signature verification part 242e of the verification apparatus 240 sends a verification end response to the smartcard 210 through the sending/receiving part 143 (S42).

Receiving the end response, the signature generation part 212f of the smartcard 210 sends the upper side one-time signature, which has been previously stored, to the verification apparatus 240 (S43).

Further, the signature generation part 212f of the smartcard 210 generates an upper side authentication path (S44), and sends the upper side authentication path to the verification apparatus 240 (S45).

Then, the verification apparatus 240 performs verification by using the one-time signature received in the step S43 and the authentication path received in the step S45 (S46), and sends a verification result (approval or rejection) as an end response to the smartcard 210 (S47).

On the side of the smartcard 210, after sending the upper side authentication path to the verification apparatus 240 (S45), the key processing part 212a generates a lower side Merkle tree to be used for the next message (S48), and generates a one-time signature as the root of the lower side Merkle tree, and stores it as the one-time signature of the upper side Merkle tree to the Merkle tree information storage part 211c (S49).

Then, the processing part 212 of the smartcard stores the received end response to the temporary information storage part hid (S50).

As described above, the present embodiment can perform signature generation and signature verification in parallel, and thus processing time can be shortened. In addition, a lower side Merkle tree required for one signature is generated one by one, and accordingly the storage capacity can be made small.

In the second embodiment described above, two stages of an upper side Merkle tree and a lower side Merkle tree are provided. This mode is not restrictive, and many stages may be provided.

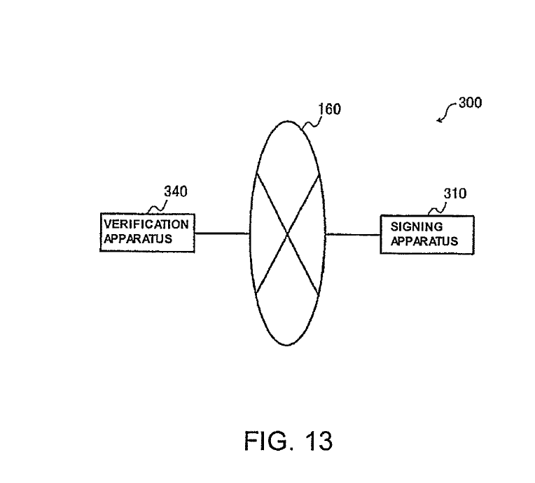

FIG. 13 is a schematic block diagram showing a signature system 300 of a third embodiment of the present invention.

As shown in the figure, the signature system 300 comprises a signing apparatus 310 and a verification apparatus 340. The signing apparatus 310 and the verification apparatus 340 are each connected to a network 160.

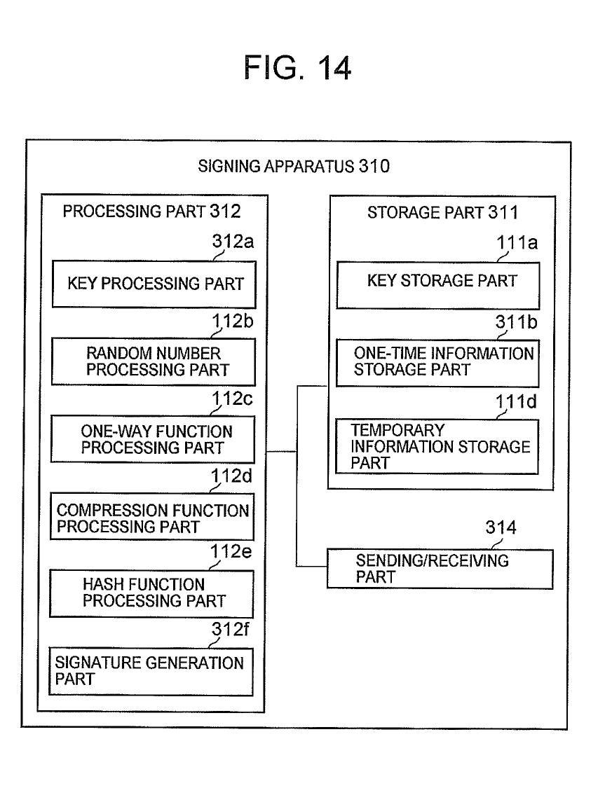

As shown in FIG. 14 (a schematic block diagram showing the signing apparatus 310), the signing apparatus 310 comprises a storage part 311, a processing part 312 and a sending/receiving part 314.

The storage part 311 comprises a key storage part 111a, a one-time information storage part 311b, and a temporary information storage part 111d.

Similarly to the first embodiment, the key storage part 111a stores information that specifies a secret seed and a public seed used for encryption by the Advanced Encryption Standard (AES).

The one-time information storage part 311b stores, for each one-time signature, indexes used for that one-time signature, secret information corresponding to each index, and a one-time public key as a root of a binary tree. In the present embodiment, these pieces of information are stored in association with a one-time signature index as identification information for identifying the one-time signature in question uniquely.

The temporary information storage part 111d temporarily stores information required for performing processing in the below-described processing part 112.

The processing part 312 comprises a key processing part 312a, a random number processing part 112b, a one-way function processing part 112c, a compression function processing part 112d, a hash function processing part 112e, and a signature generation part 312f.

Similarly to the first embodiment, the key processing part 112a generates secret information used for a one-time signature. Secret information is generated by performing AES encryption on each index used for a one-time signature by using the secret key stored in the key storage part 111a as a key.

Secret information generated by the key processing part 112a is stored together with the corresponding index to the one-time information storage part 311b.

Further, in the present embodiment, although the AES encryption is performed, this mode is not restrictive. For example, another block cipher or a hash function may be employed.

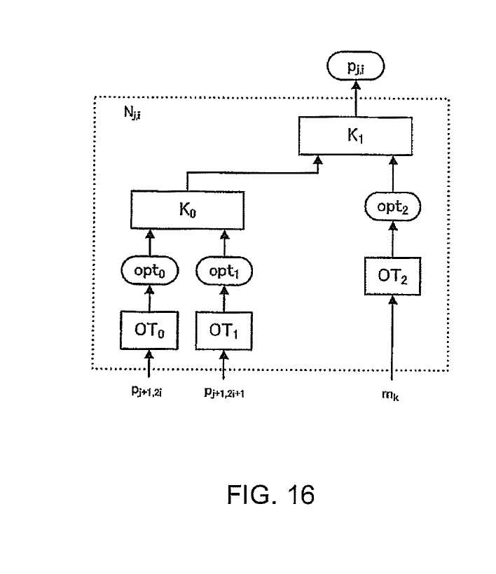

Further, in the present embodiment, the key processing part 112a generates the below-described node (See FIG. 16) for each message to be signed, and stores a one-time public key used in the generated node in association with the one-time signature index assigned to the binary tree structure included in the generated node to the one-time information storage part 311b.

The random number processing part 112b, the one-way function processing part 112c, the compression function processing part 112d and the hash function processing part 112e perform processing similar to the first embodiment.

The signature generation part 312f generates a one-time signature by processing similar to the second embodiment.

The sending/receiving part 314 is an interface for sending and receiving information through the network 160, and may be implemented by an NIC.

The above-described signing apparatus 310 can be implemented by a so-called computer as shown in FIG. 21.

For example, the storage part 311 can be implemented by the external storage 193. The processing part 312 can be implemented when prescribed programs stored in the external storage 193 are read to the memory 192 and executed by the CPU 191. The sending/receiving part 314 can be implemented by a communication unit 196 such as an NIC.

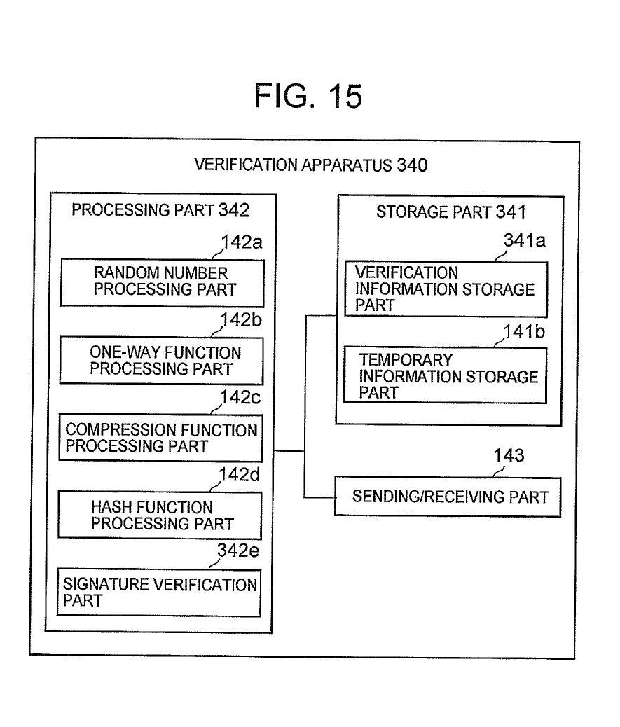

FIG. 15 is a schematic bloc diagram showing the verification apparatus 340.

As shown in the figure, the verification apparatus 340 comprises a storage part 341, a processing part 342 and a sending/receiving part 143.

The storage part 341 comprises a verification information storage part 341a and a temporary information storage part 141b.

The verification information storage part 141a in the present embodiment stores information used for verifying a one-time signature received from the signing apparatus 310.

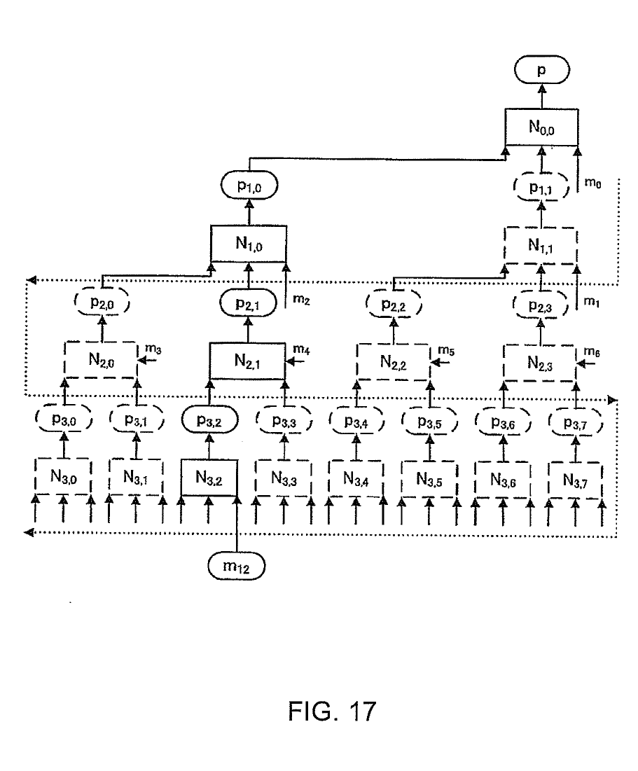

For example, in the present embodiment, the verification information storage part 141a stores information that specifies the tree structure shown in FIG. 17.

The temporary information storage part 141b temporarily stores information required for performing processing in the below-described processing part 142.

The processing part 342 comprises a random number generation part 142a, a one-way function processing part 142b, a compression function processing part 142c, a hash function processing part 142d, and a signature verification part 342e.

The random number processing part 142a, the one-way function processing part 142b, the compression function processing part 142c and the hash function processing part 142d perform processing similar to the first embodiment.

The signature verification part 342e calculates a one-time public key from a one-time signature sent from the signing apparatus 310, calculates a compressed value that is obtained by compressing a plurality of (two in the present embodiment) one-time public keys sent from the signing apparatus 310 by a compression function, calculates a public key for each node by compressing the calculated one-time public key and the compressed value by a compression function, and calculates a master public key for the system as a whole from the public keys for the nodes. Details of this processing will be described referring to FIG. 17.

The sending/receiving part 143 is an interface for sending and receiving information through the network 160, and may be implemented by an NIC, for example.

Similarly to the first embodiment, the above-described verification apparatus 140 can be implemented by a so-called computer shown in FIG. 21.

For example, the storage part 341 can be implemented by the external storage 193. The processing part 342 can be implemented when prescribed programs stored in the external storage 193 are read to the memory 192 and executed by the CPU 191. And, the sending/receiving part 143 can be implemented by the communication unit 196 such as an NIC.

FIG. 16 is a diagram for explaining a node N_{j,i} used in the present embodiment.

Here, the subscript (i, j) added to a node N_{j,i} indicates an index of the node. The index of a node will be described referring to FIG. 17.

A node N_{j,i} comprises three binary tree structures OT₀, OT₁ and OT₂ and two compression functions K₀ and K₁.

In each node N_{j,i}, a public key P_{j+1,2i} calculated in another node N_{j+1,2i} is inputted to the binary tree structure OT₀ to calculate a one-time public key opt₀, and a public key P_{j+1,2i+1} calculated in another node N_{j+1,2i+1} is inputted to the binary tree structure OT₁ to calculate a one-time public key opt₁, and these one-time public keys opt₀ and opt₁ are compressed by the compression function K₀ to calculated a compressed value.

Further, in each node N_{j,i}, a message mₖ to be signed is inputted to the binary tree structure OT₂ to generate a one-time signature, and a one-time public key opt₂ is calculated from the generated one-time signature.

Then, the compressed value obtained by compression by the compression function K₀ and the one-time public key opt₂ are compressed by the compression function K₁, to calculate a public key P_{j,i} for the node N_{j,i}.

For example, to sign a message mₖ, the signature generation part 312f of the signing apparatus 310 generates partial one-time signatures from the message mₖ, sends the generated partial one-time signatures to the verification apparatus 340 so that the verification apparatus 340 applies the partial one-time signatures to a node N_{j,i} to calculate a public key P_{j,i} for the node.

As described above, the random number processing part 112b combines, as its input, not only the index of the compression function or the one-way function but also the index of the node, to calculate an initial vector. For example, an initial vector for K₄ in the node N_{2,1} 1131 is calculated not simply by AEₛₚ(4) but by AESₛₚ(2∥1∥4).

FIG. 17 is a diagram for explaining processing for verification in the signature system 300 of the present embodiment.

First, in the signature system 300, one node N_{0,0} is generated. And, the master public key for the system becomes p i.e. the root of the node N_{0,0}.

One node N_{0,0} can sign only one message m₀. Thus, to sign the next message m₁, it is necessary to generate another node N_{1,1} belonging to a level lower than the node N_{0,0} for calculating the master key.

In the present embodiment, one node can be associated with two child nodes. Thus, the node N_{0,0} is associated with nodes N_{1,0} and N_{1,1}.

Then, the node N_{1,0} is generated for the subsequent message m₂. And, for the subsequent message m₃, another node N_{2,3} belonging to a level lower than the node N_{1,0} is generated. In this way, by generating child nodes successively from the node N_{0,0} that becomes the root, an infinity of message can be signed in the present embodiment.

Here, it is favorable to interlace selection of nodes in parent-child levels. In other words, when selection of nodes is performed in the right-to-left direction in one level, then it is favorable to select leaves in the left-to-right direction in the next level. Interlacing of node selection is performed since change from the last node in one level to the next node in the next level becomes smallest when selection is performed by interlacing. For example, in the case where a message m₆ is signed by using the node N_{2,3}, the node N_{3,7} is located just under the node N_{2,3} while the node N_{3,0} is located on the opposite side of the node N_{2,3}. Thus, when the node N_{3,7} is selected for the next message m₇, the path to the public key p in the signature verification using the node N_{2,3} can be used as it is.

In the case where the signature verification part 342e of the verification apparatus 340 verifies a signature of the message m₁₂ shown in FIG. 17, a one-time public key is calculated from the one-time signature for the message m₁₂, to calculate a public key p_{3,2} for the node N_{3,2}. Then, thus-calculated public key p_{3,2} is inputted to the parent node N_{2,1} of the node N_{3,2}, to calculate a public key p_{2,1} for the node N_{2,1}. By repeating such processing up to the root node N_{0,0} of the system, a master public key p for the system can be calculated. Verification can be performed by comparing the thus-calculated master public key p with the master public key stored in the verification information storage part 341a and judging whether both master public keys coincide.

Such parent-child relations between nodes are previously stored in the verification information storage part 341a.

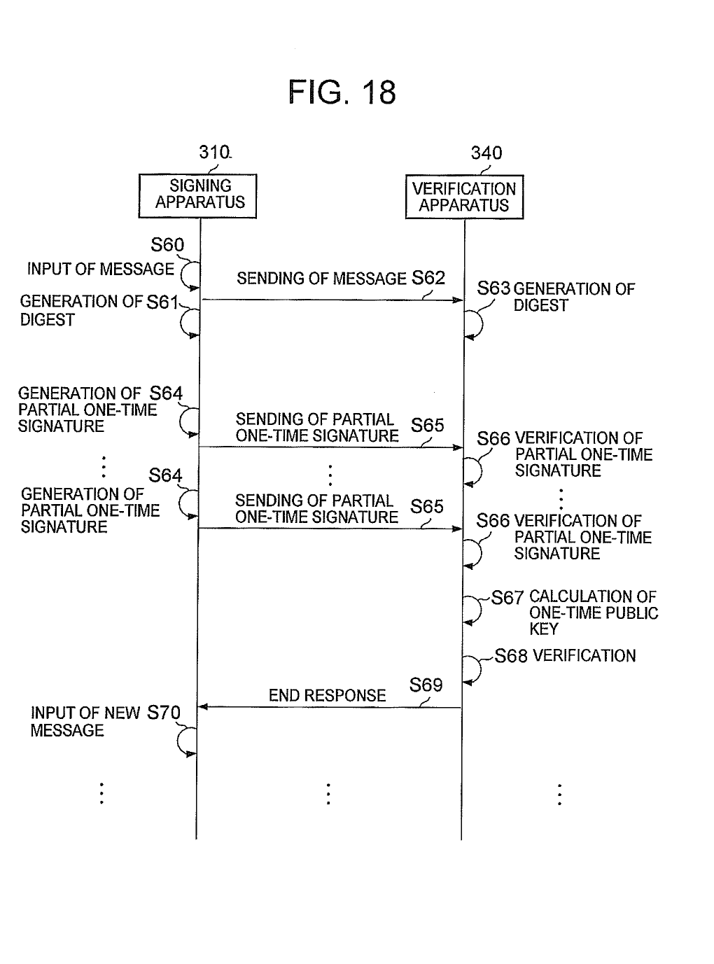

Processing in the above-described signature system 300 of the third embodiment will be described referring to the sequence diagram shown in FIG. 18.

First, the signing apparatus 310 receives input of a message m₀ to be verified, and stores the received message m₀ to the temporary information storage part 111d (S60). Here, the message m₀ may be received through an input unit such as a keyboard.

Then, the hash function processing part 112e calculates a digest H(m₀) of the received message m₀ by using a prescribed hash function H (S61).

The inputted message m₀ is sent to the verification apparatus 340 through the sending/receiving part 314 (S62).

Then, also the hash function processing part 142d of the verification apparatus 340 calculates the digest H(m₀) of the received message m₀ by using the prescribed hash function H (S63).

Next, the signature verification part 342e of the verification apparatus 340 generates a node N_{0,0} for signing the message m₀ (S64).

Next, the signature generation part 312f of the signing apparatus 310 divides the digest H(m₀) of the message m₀ into quits starting from the first bit of the digest and generates partial one-time signatures (S65), and sends the partial one-time signatures in sequence of generation to the verification apparatus 340 (S66).

Receiving the partial one-time signatures, the verification apparatus 340 identifies a quit corresponding to each of the received partial one-time signatures on the basis of the digest H(m₀) generated in the step S63, to specify the number of times of input to one-way functions. Then, by inputting to the one-way function processing part 142c, a leaf of the binary tree is calculated by using the public seed stored in the verification information storage part 241a (S67). By repeating the processing of the steps S65-S67 for all the bits of the digest H(m₀), all leaves of the binary tree are calculated. These leaves are inputted to the compression function processing part 142c, to calculate a one-time public key (S68).

Then, the signature verification part 342e of the verification apparatus 340 input the one-time public key calculated in the step S68 to the node N_{0,0} generated in the step S64, to calculate a public key for the node N_{0,0}, and verification is performed (S69).

In the case where the signature can be approved as a result of the verification in the step S69, the signature verification part 342e of the verification apparatus 340 sends an end response to the signing apparatus 310 through the sending/receiving part 143 (S70).

Receiving the end response, the signing apparatus 310 receives input of a new message (S71), and repeats the processing of the steps S62-S70 until no message to be sent exists.

As described above, in the present embodiment, verification can be performed by generating nodes sequentially depending on message to be signed. Thus, similarly to the conventional Secure Socket Layer (SSL), the present embodiment can be used for an Internet user to authenticate a website.

By using the Merkle signature as in the present embodiment, it is possible to assure security of authentication even in the case where a quantum computer is used.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A signature system in which a digital signature generated by a first computer is verified by a second computer, wherein:
a processing part of the first computer divides data to be signed digitally into groups of a specific number of bits sequentially starting from a top bit of the data, inputs each group to a one-way function so as to generate respective partial signatures for the groups, and outputs the generated partial signatures sequentially to the second computer.

2. A signature system of claim 1, wherein:
a processing part of the second computer generates a one-time public key by compressing the partial signatures by a compression function, generates a master public key from the one-time public key, and performs verification by comparing the generated master public key with a master public key previously stored in a storage part.

3. A signature system of claim 1, wherein:
the processing part of the first computer generates the partial signatures in such a way that a number of times of inputting secret information assigned uniquely to each of the groups to the one-way function is different depending on a value shown by the bits included in the group in question.

4. A signature system of claim 3, wherein:
the processing part of the second computer generates the master public key:
by specifying, for each of the partial signatures, a value calculated by substituting the partial signature in question to the one-way function a number of times obtained by subtracting the number of times of inputting to the one-way function in the first computer from a predetermined number of times; and
by compressing the specified calculated values two by two by a compression function to obtain compressed values, which in turn compressed two by two by the compression function, compression being repeated up to obtain the master public key.

5. A signature system of claim 1, wherein:
the one-way function is a hash function.

6. A signature system of claim 2, wherein:
the compression function is a hash function.

7. A signature system of claim 3, wherein:
the one-way function is a block cipher;
the block cipher operates by inputting the secret information as key information and by encrypting an initial vector generated at random.

8. A signature system of claim 4, wherein:
the compression function is a block cipher;
the block cipher operates:
by encrypting an initial vector generated at random by first key information, to generate first encrypted information;
by encrypting the first encrypted information by second key information, to generate second encrypted information; and
by encrypting the second encrypted information by the first key information; and
the first key information and the second key information are each the calculated value or the compressed value.

9. A signature system of claim 2, wherein:
the processing part of the second computer:
generates the one-time public key by compressing the partial signatures by the compression function;
generates a first public key from the one-time public key;
generates a one-time signature from the first public key; and
compresses the one-time signature by the compression function to generate a one-time public key; and
repeats the processing of generating the second public key from the one-time public key, up to an n-th public key (n: any natural number greater than or equal to 2); and
performs verification by comparing the n-th public key with an n-th public key previously stored in the storage part.

10. A signature method in which a digital signature generated by a first computer is verified by a second computer, comprising:
a step in which a processing part of the first computer divides data to be signed digitally into groups of specific number of bits sequentially starting from a top bit of the data generating partial signatures, inputs each group to a one-way function so as to generate respective partial signatures for the groups; and
a step in which the processing part of the first computer outputs the generated respective partial signatures for the groups sequentially to the second computer.
